(19) United States
(12) Patent Application Publication
(10) Pub. No.: US 2004/0102939 A1
(43) Pub. Date: May 27, 2004

(54) Simplist yet process for describing the universe

(76) Inventor: John R. Ross, Del Mar, CA (US)

Correspondence Address: JOHN R. ROSS, PO BOX 2138, DEL MAR, CA, 92014, US

(21) Appl. No.: 10/703,048

(22) Filed: Nov. 6, 2003

Related U.S. Application Data
(63) Continuation-in-part of application No. 10/655,817, filed on Sep. 5, 2003.
(63) Continuation-in-part of application No. 10/436,286, filed on May 12, 2003.
(63) Continuation-in-part of application No. 10/251,577, filed on Sep. 21, 2002.
(63) Continuation-in-part of application No. 09/908,297, filed on Jul. 17, 2001.

(51) Int. Cl. G06F 17/10

(52) U.S. Cl. 703/2

(57) ABSTRACT

Processes for describing and explaining all elements of the universe including photons, electrons, protons, neutrons, atomic nuclei, heat, temperature, magnetism and gravity. According to this model, the entire universe and everything in it from photons to electrons to protons to galaxies is comprised of nothing but a single type of elementary charged point particle. I call these “pointicles”, “tronnies”. A tronnie has no mass and no volume but it has a charge equal to +e or −e (i.e., about +1.6×10⁻¹⁹ coulomb or about −1.6×10⁻¹⁹ coulomb). Also, according to this modes the only forces in the universe are Coulomb forces produced by these tronnies. Every tronnie possesses a Coulomb force field resulting from its charge that travels out spherically from the tronnie's position at the speed of light. Each tronnie is repelled by the force fields of tronnies with like charges and attracted by the force fields of tronnies with opposite charges. According to Coulomb's Law the force between charges is inversely proportional to the square of the distance between the charges and approaches infinity as the distance approaches zero. Each tronnie is repelled by its own force field so that each and every tronnie is doomed to travel at speeds never less than the speed of light. This model of the universe follows directly from Coulomb's Law that on careful analysis requires that the elementary charge be a point charge.

This Application is a Continuation-in-Part application of Ser. No. 10/655,817 filed Sep. 5, 2003, Ser. No. 10/436,286 filed May 12, 2003, Ser. No. 10/251,577 filed Sep. 21, 2002 and Ser. No. 09/908,297, filed Jul. 17, 2001, which was a Continuation-in-Part of Ser. No. 10/161,823 filed Jun. 3, 2002, now abandoned, all of which are incorporated herein by reference. The present invention relates to processes for analyzing nature and for making and supporting models for analyzing nature and the universe.

### BACKGROUND OF THE INVENTION

### Search for the Truth

Since the beginning of human civilization mankind has searched for explanations of the origin of the universe and how it works. Early explanations involved supernatural beings and religions evolved from these efforts. More recent explanations have involved complicated mathematical explanations based on experimental evidence, some involving multiple extra dimensions. Many millions of dollars are being spent in the United States alone and similar efforts are underway in other countries in search of an ultimate theory or explanation that fully explains all of nature. Popular theories include several complicated elementary particles that are suppose to be building blocks of matter and a complicated set of forces; however, these theories do not adequately explain some of the fundamental elements of nature. Prior art theories do not, for example adequately describe light or the electron. Light is usually treated as a wave but has particle properties and the electron is normally treated as a particle but has wave-like properties.

Stephen Hawkins in his book, The Theory of Everything, complained that science had become too complicated for philosophers and that they had ceased asking questions such as “Did the universe have a beginning?” and he concluded his text as follows: “However, if we discover a complete theory, it should in time be understandable in broad principal by everyone, not just a few scientists. Then we shall all be able to take part in the discussion of why the universe exists. If we find the answer to that, it would be the ultimate triumph of human reason. For then we would know the mind of God.”

What is needed is a process for modeling the universe that is so simple as to be understood by everyone and a process for proving that the model of the universe is correct.

### SUMMARY OF THE INVENTION

### Ross Model of the Universe

I have proposed what I believe is the simplest yet model of the universe. I call my model the “The Ross Model of the Universe”. Processes described and claimed herein can be used to describe and explain all elements of the universe including photons, electrons, protons, neutrons, atomic nuclei, heat, temperature, magnetism and gravity. According to this model, the entire universe and everything in it from photons to electrons to protons to galaxies is comprised of nothing but a single type of elementary charged point particle. I call these “pointicles”, “tronnies”. A tronnie has no mass and no volume but it has a charge equal to +e or −e (i.e., about +1.6×10⁻¹⁹ coulomb or about −1.6×10⁻¹⁹ coulomb). Also, according to this model the only forces in the universe are Coulomb forces produced by these tronnies. Every tronnie possesses a Coulomb force field resulting from its charge that travels out spherically from the tronnie's position at the speed of light. Each tronnie is repelled by the force fields of tronnies with like charges and attracted by the force fields of tronnies with opposite charges. According to Coulomb's Law the force between charges is inversely proportional to the square of the distance between the charges and approaches infinity as the distance approaches zero. Each tronnie is repelled by its own force field so that each and every tronnie is doomed to travel at speeds never less than the speed of light. This model of the universe follows directly from Coulomb's Law that on careful analysis requires that the elementary charge be a point charge.

### Photons

Every photon is comprised of one plus tronnie and one minus tronnie traveling in an oscillating pattern such as a double helix or two criss-crossing sine patterns. These patterns define the photon's wavelength and corresponding energy. The two tronnies are always positioned in a plane perpendicular to the photon's direction and their separation is never more than one-half the photon's wavelength. Therefore, the length of a photon in its direction of travel is zero and its width corresponds to one-half its wavelength.

### Electrons

Three photons, one of which is a high-energy photon, combine in pair production to produce a pair of electrons (a negatron and a positron). The negatron (the negative electron) is comprised of a plus tronnie orbiting in a tight circle of radius r at a speed of 1.57 times the speed of light with two minus tronies orbiting around the circular path of the plus tronnie, also at radius r, one-fourth period behind the plus tronnie. The positron is comprised of a minus tronnie and two plus tronnies with their positions reversed from that of the negatron. Although tronnies have no mass and as such provide no resistance to any applied force, when a tronnie combines with two other tronnies to form an electron, the resulting dynamic combination does provide a resistance to applied forces. This is the creation of substantially stationary “energy” or its equivalent, “mass”. Plus and minus electrons capture photons that propel the electrons, increasing their energy (and correspondingly their mass).

### Neutrinos

Neutrinos are very high-energy photons. In a neutrino the separation between its two tronnies is much less than the dimensions of atoms and is also smaller than the dimensions of protons. Therefore neutrinos can pass right through atoms and even protons. However, electrons including the electrons making up protons (see the next section) can occasionally capture neutrinos. Neutrinos captured by electrons can increase the mass/energy of the electrons by factors of several hundred.

### Protons and Neutrons

Three very high-energy electrons (one negatron and two positrons) combine to form each proton. The path of the negatron in a proton is similar to the path of the minus tronnie in the positron and the paths of the two negatrons are similar to the paths of the two minus tronnies in the negatron. Protons and electrons are enormously stable, probable (with the exception of tronnies which may be indestructible) they are the most stable things in the universe; however, they are easily destroyed by combination with their anti-particle. A neutron is a proton with an extra negatron.

### Atoms

Protons and neutrons are held together in the nuclei of atoms in Coulomb force wells by the Coulomb forces (not the “strong force”). The neutron may lose its identity inside the nucleus of an atom so nuclei of atoms may be nothing more than a combination of protons and electrons in dynamic equilibrium. Some specific configurations are proposed herein.

### Heat, Temperature, Magnetism and Gravity

Heat is nothing more than photons (or tronnie pairs) trapped in matter. Temperature is a measure of that heat. Magnetism results when plus and minus tronnies are encouraged to travel in large loops (such as through the earth, out one pole and in the other pole or through a bar magnet or through the center of a current carrying coil of wire). Gravity result from the Coulomb forces progressing rearward along the trail of tronnies (especially the two tronnies making up each neutrino) as they pass near charges. These charges may be the tronnies comprising matter, such as the matter making up the earth or these charges could be the charges making up a beam of light. These Coulomb forces are expanding backward toward the source of the neutrinos and the forces are exerted on charges in the matter so that the forces tend to push the matter back toward the source of the tronnies. The neutrino flux from a source such as the sun decreases as the square of the distance from the source. This correlates with the inverse square gravitational effect.

### Ross Model Consistent with Other Experimental Results

These are merely examples. This basic model proposed here appears to be consistent with all experimental results relating to particle physics, chemistry, optics, fusion and fission that I have considered. The Ross Model can be used to explain radio waves, electric current flow, the thermoelectric effects, and the beginning and end of the universe. I admit that some of my explanations are speculative and I am sure that people more familiar with particular technologies than 1 can improve on my explanations. When they do I will just modify my model to accommodate the better explanations. I have already modified my model numerous times since my first model about three years ago. The model has gotten simpler with each modification.

### BRIEF DESCRIPTION OF THE DRAWINGS

FIG. 1 is a representation of a single tronnie pushed by its own force field. The speed of force field is c=3×10⁸ M/S.

FIG. 2 is a drawing of a tronnie pair in orbit. The period T=1/f=λ/c=λ/3×10⁸ m/s.

FIGS. 3A and 3B are drawings of a photon.

FIGS. 4A and 4B represent a plane polarized photon.

FIG. 5 represents a neutrino with a λ<10⁻¹⁵ m.

FIG. 6 is a representation of an electron comprising three tronnies one plus and two minuses in a tripple tron twirl. View is 30 degrees to plane of the circling plus tronnie. Paths of minus tronnies below the plane of the circling plus tronnie are shown as dots and small dashes.

FIG. 7 is a simple electric circuit. Mass-less minus tronnies are responsible for the fast (almost at the speed of light) flow of electricity one mile from switch to lamp.

FIG. 8 is a light emitting diode. Photons produced by combining plus and minus tronnies.

FIG. 9 represents a proton. A negatron 322 pushed by neutrino 322A traverses circular path in one period, T. Two positrons 324 and 326 also pushed by neutrinos 324A and 326A orbit in time T the path of negatron 322 (¼ T behind negatron 322).

FIGS. 10A and 10B are possible configurations of a neutron. A proton with an extra negatron pushed by a neutrino.

FIG. 11A is a suggested model of a deuterium nucleus.

FIG. 11B is a suggested model of a tritium nucleus.

FIG. 11C is a suggested model of a helium 4 nucleus or an alpha particle.

FIGS. 12A through 12E depicts a melting crystal.

FIGS. 13A through 13E describes types of magnetism

FIGS. 14A through 14E describes exothermic chemistry.

FIG. 15 describes the thermoelectric effect.

FIG. 16 describes gravity.

### DETAILED DESCRIPTION OF PREFERRED EMBODIMENTS

### The Ross Model of the Universe

### Tronnies

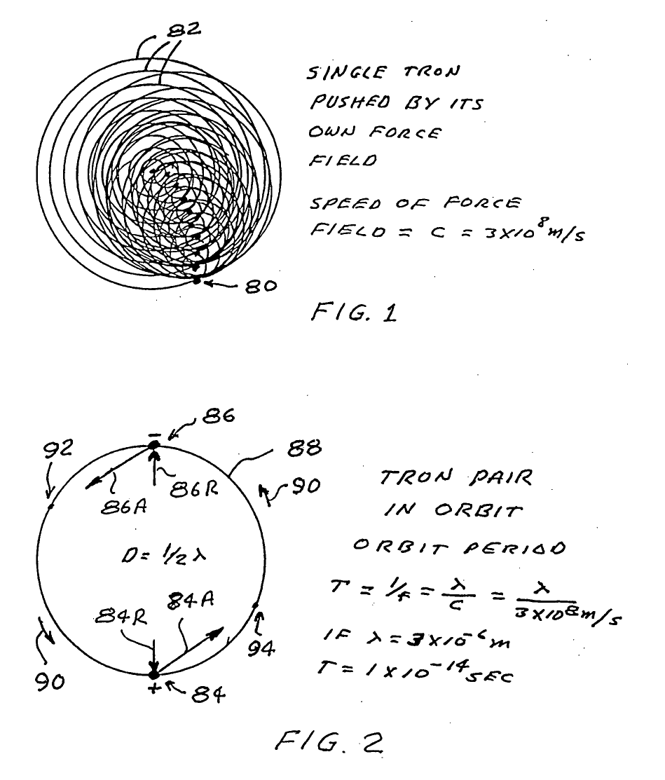

FIG. 1 is a drawing of a single negative tronnie 80. It is a point. It has no mass and no volume, it possesses only a negative charge (−e) and the Coulomb force associated with its negative charge. This force is in the form of a force field that proceeds out from the tron point in spheres expanding at the speed of light. Tronnie 80 is being pushed out by its own Coulomb force fields as shown in FIG. 1. The space between the expanding circles represent a fixed time period such as a nanosecond or a second and a corresponding distance. If the time period is a second then the distance is 300 million meters! If the time period is one billionth of a second then the distance is about a foot. If the time period is a billionth of a billionth of a second (10⁻¹⁸ second), the distance is atomic size (3×10⁻¹⁰ m). Three of the circles expanding out from the location of tronnie 80 nine time intervals in the past are shown at 82. So you can see tronnies are very little and very fast which may be why we have lived with them for so long without recognizing them.

If the tronnie is not tied to one or more other tronnies in some sort of association, it may travel through the universe along routes that seem random being pushed and pulled by other Coulomb forces everywhere present in the universe. It may also pair up with an opposite tronnie and the pair may travel in circles of any dimension at speeds of 1.57 c while its Coulomb force field travels at a speed of c. When trapped in a solid, liquid or gas, the tronnie is usually paired up with an opposite tronnie and the pair is associated with an electron an atom or a molecule. The tronnie may also in some cases take longer loops in matter to create what is known as lines of force in a magnetic field. As a photon it normally travels in a helical path along with its partner both orbiting in the same direction. A gamma ray photon comprised of two tronnies orbiting with each other in a helical orbit at a frequency such as 2.46×10²⁰/second has mass (energy) of 18.22×10⁻³¹ kilograms (1.02 MeV). The three tronnies in an electron at rest together have a mass (energy) of 9.11×10⁻³¹ kilograms (0.51 MeV).

### How Do I Convince a Skeptical World that I Have Found the Secret of the Universe?

Some of the smartest people in the world have been searching for centuries for a model of the universe as simple and all-inclusive as the one briefly described above. A natural reaction of some people is to reject any model so simple as this one on the basis that if it were that simple someone would have proposed it long ago and it would have been accepted. However, if and when my model is ultimately confirmed to be basically correct, many will probably claimed to have thought of it long ago. This is the main reason why I have been submitting my ideas as I have developed them over the past three years as patent applications to the United States Patent Office. Earlier versions are described in patent applications (identified in the first sentence of this specification) that have been published as application by the United States Patent and Trademark Office in USPTO web pages. The published applications can be found by searching with “Ross” as inventor with the addition of a key word such as “neutron” or “proton”. With these publications it should be clear that I am the discoverer of these mass-less, volume-less point particles (pointicles) with a charge of e and which always travel as fast or faster than the speed of light and are the building blocks of everything in the universe. I believe that I have discovered the Secret of the Universe. This secret was right before the eyes of Professor Einstein, Professor Feynman and all of the other great scientist who have spent much of their lives in search of these elementary pointicles. My problem now is: “How do I prove it?”

### The Ross Model of the Universe Can Be Derived from Coulomb's Law

Coulomb's Law says that the force between two charges is proportional to the product of the charges and inversely proportional to the square of the distance between them. A natural consequence of this law is that elementary charged particles must be point charges with no volume or any other dimension. Otherwise, the particle would blow itself apart with infinite or near infinite forces. It is obvious that a point cannot have mass. Infinite density makes no sense. Therefore, all charged particles must be charged point particles or be made up of charged point particles. The question is: “Could a elementary charged point particle travel at speeds less than the speed of light.” The answer is “No”. The Coulomb force on a charge A from a like charge B is felt by A based on the position of B when the force (traveling at the speed of light and reaching A) left B. Therefore, if a mass-less point charge ever attained a speed greater than the speed of light forces from its own past would assure that it never slowed down to a speed of less than the speed of light. I believe no tronnie ever traveled slower than the speed of light but if it did the Coulomb forces from two nearby like charges (each pushing the particle at the speed of light) would drive the mass-less point particle away at speeds greater than the speed of light. Once it is going away from a past position faster than the speed of light its own past (especially its immediate past) will keep it going at at least the speed of light. Therefore, every elementary charged particle in the universe is doomed to always travel at speeds equal to or greater than the speed of light.

### Examples of Things Made from Tronnies

According the model on which this invention is based, everything in the universe is made from tronnies. This application describes and claims processes for describing and explaining elements of the universe based on this model. Thus, all elements of the universe are comprised of only these mass-less, volume-less particles with their charge of either plus e or minus e. Specific examples of elements that can be described and explained by this process include tronnie pairs, photons, radio waves, neutrinos, positron and electrons, energetic electrons, electric current, protons and neutrons, atoms, heat and temperature, magnetism, chemical energy, fission and fusion, the thermoelectric effect, gravity, black holes, receding galaxies and the beginning and the end of the universe. The reader should note here that these are merely examples of possible explanations and description for these elements. Persons that are expert in the various fields in which these elements are important can undoubtedly improve on my explanations using the basic model of the universe described above.

Tronnie Pairs

FIG. 2 is a drawing of a tronnie pair. (Tron pairs may take the form of photons traveling at the speed of light or they may be trapped in matter, circling [for example] a relatively stationary electron, atom or molecule.) A plus tronnie 84 and a minus tronnie 86 have joined together in a mutual attraction self repulsion orbit along path 88 in direction 90. The wavelength of the tronnie pair is λ. The period of the orbit is T=1/f=λ/c where f is the frequency. The wavelength could be any length. For example if λ is 3×10⁻⁶ m, then T would be 1×10⁻¹⁴ second. The orbit diameter is 1/2λ. Minus tronnie 86 is located at the position shown for 86 at time, t=0. At time t=−0.5 T minus tronnie 86 was located at the position 84 on the opposite side of circle 88. At time t=about −0.3 T plus tronnie 84 was located at position 92 and minus tronnie 86 was located at position 94. The forces on tron 86 are shown by arrows 86A, 86R, and the forces on tronnie 84 are shown by arrows 84A and 84R. Thus, repulsive forces 86R and 84R keep the two tronnies located on tangents of circle 88 and attractive forces 86A and 84A keep the two tronnies directed around the circle at a frequency of 1×10¹⁴/second (ten thousand billion times per second!).

Photons

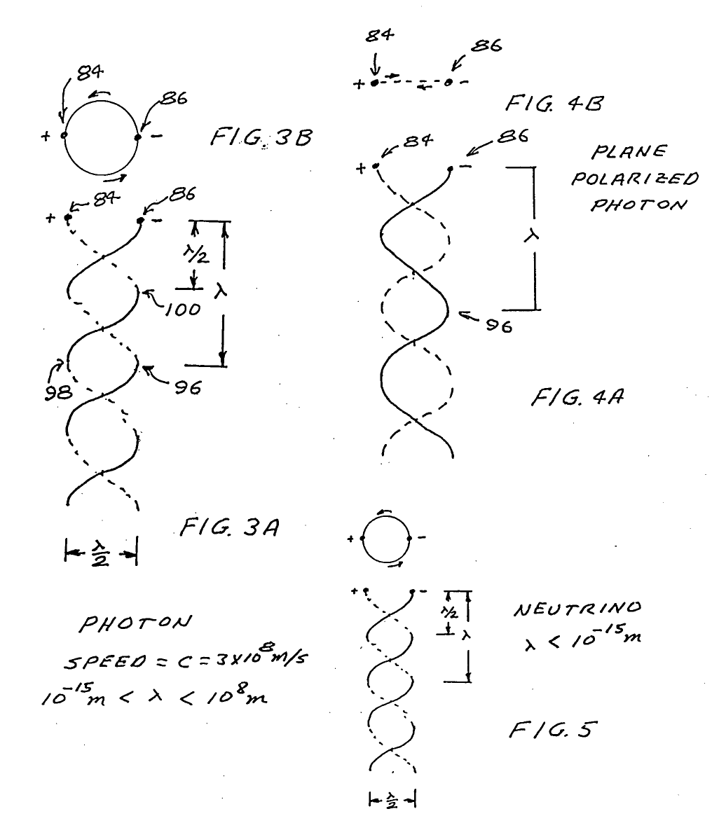

A photon is depicted in FIGS. 3A and 3B as a plus tronnie and a minus tronnie with wavelength λ moving along a double helical path at a speed of c. In this case each tronnie in the tronnie pair shown in FIG. 3B is pushed in a direction perpendicular to the plane of orbit by its own force field from one wavelength back on its helical path. For example, the expanding force field of minus tronnie 86 originating from its location at position 96 (one wavelength back) arrives at position shown for tronnie 86 the same time tronnie 86 arrives there. Also, force fields from two, three, four, etc wavelengths back also arrive at the tron position shown at 86 the same time tronnie 86 arrives there. Tronnie 84 is similarly pushed along. (The reader should note that the attractive force field from tronnie 84 when it was at location 100 also arrives at the position of tron 86 at the same time as the repulsive force of tronnie 86 from location 96. I believe that the attractive Coulomb force from tronnie 84 moving in synchronization with tron 86 serves to help lock tron 86 in its helical path and instead of pulling tronnie 86 back; i.e., the Coulomb force from tron 84's path actually helps pull tronnie 86 along on their helical orbit.)

A polarized photon may be modeled as two tronnies oscillating along a line that is moving at the speed of light perpendicular to the photon direction as shown in FIG. 4B. In this case the photon would map out from the side view two crisscrossing sine functions as shown at in FIG. 4A. I suspect that the photon can proceed in a variety of modes other than the two shown in FIGS. 3A and B and 4A and B. For example, the orbit direction (shown as counter clockwise in FIG. 3B could be clockwise. Elliptical orbits may be possible.

Radio Waves

According to a preferred version of the Ross Model, low frequency radio waves travel out from antenna as alternating pulses of plus and minus tronnies and generally not as photons. In each pulse the tronnies (all of the same charge) propel themselves spherically outward at the speed of light. As they travel outward each tronnie leaves a trail of Coulomb force which helps pull the oppositely charged tronnies in the immediately following pulse of tronnies. When these pulses of tronnies encounter an antenna they are absorbed by it, charge it with their charge so that the antenna is attractive for the oppositely charged tronnies in the immediately following pulse of tronnies. A properly designed electronic circuit with an oscillator, oscillating in synchronization with the radio transmitter isolates and detects the radio signal imposed on the radio beam.

Higher frequency radio waves such as those produced by half wave antennae probably travel as polarized photons like the one shown in FIGS. 4A and 4B. Each photon is made up of a plus and a minus tronnie emitted simultaneously from opposite ends of the half wave antenna.

Neutrino

Scientist tell us that more than 150 million neutrinos mostly from the sun pass through each square centimeter of the earth each second and a very large fraction of that number pass right through the earth. FIG. 5 is a drawing of a neutrino according to preferred versions of the Ross Model. According to this model a neutrino is a very high-energy (short wavelength, shorter than 1×10⁻¹⁵ m) photon. The reader should note that typical charts showing the electromagnetic spectrum show wavelengths between about 1×10⁻¹⁵ m and 1×10⁸ m. Note that 1×10⁻¹⁵ m is about the size of a proton. The distance across a typical atom is about 100 thousand times larger and the atom is almost all empty space. This means that photons smaller than 1×10⁻¹⁵ m would pass right through most things. The maximum separation between the two tronnies in the neutrino photon (one half its wavelength) is roughly about one-millionth the separation of the tronnies in an X-ray photon. X-rays pass through our bodies. Neutrinos pass through the earth.

Positrons and Electrons

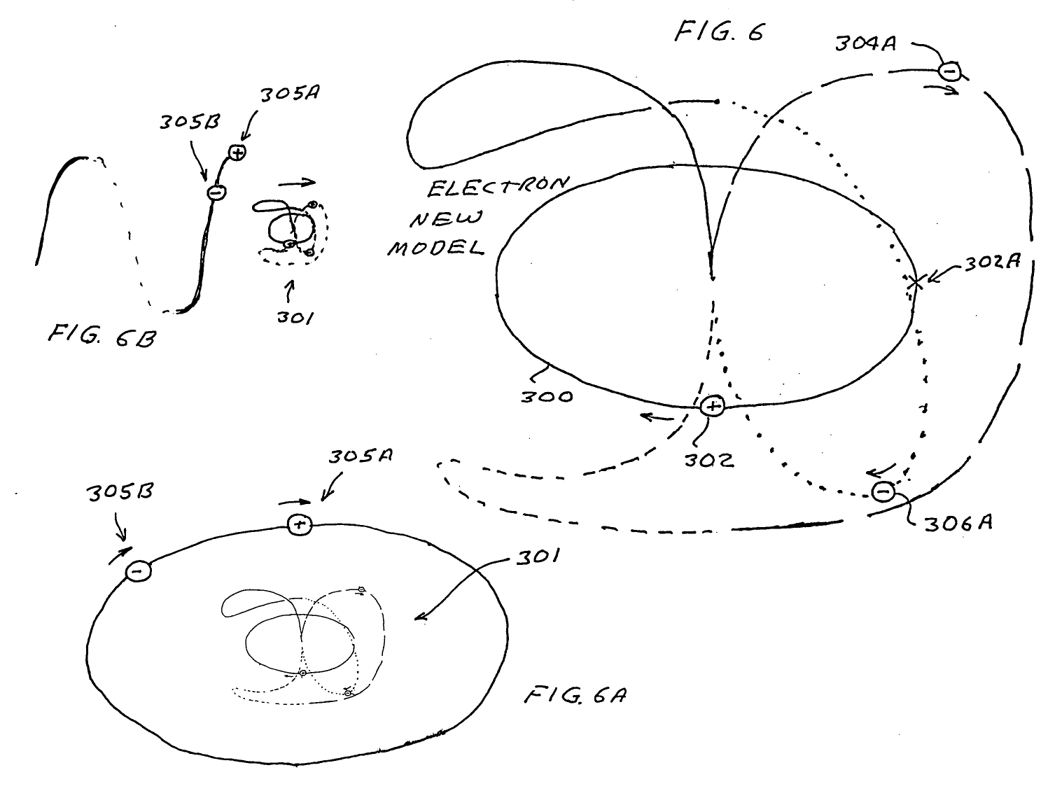

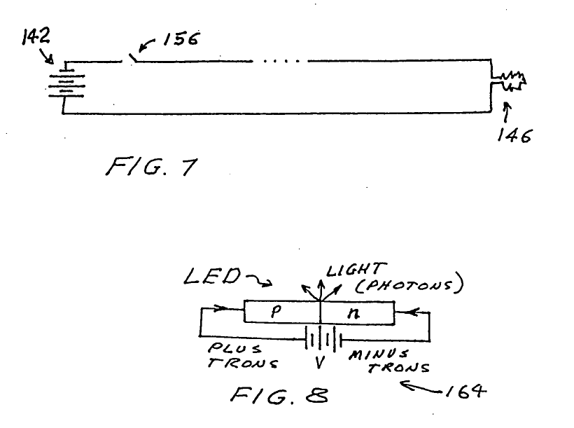

My latest negatron model is shown in FIG. 6. A plus tronnie 302 follows a circular path and two minus tronnies 304A and 306A orbit the path one fourth period behind the circling plus tronnie. The negatron in this figure is viewed from a position 30 degrees above the plane of the plus tronnie's circular path 300. The path of minus tronnie 304A is shown in long dashes above the plus tronnie's plane and short dashes below the plane. The path of the minus tronnie 306A is shown in solid line above the plane and dots below the plane. FIG. 6 represents a snap shot drawing at a time, t=0. Three arrows show the direction of the three tronnies at the time of the snap shot. The positron is exactly the same as a negatron except the sign of the three tronnies are reversed. The central circling tronnie is a minus tronnie and the two tronnies orbiting the circular path are plus tronnies. The positron and the negatron may be produced in a pair production process as explained above as the result of the marriage of one high-energy photon with two lower energy photons trapped in matter. I suspect that the minus tronnie of the high energy photon can desert its mate, the plus tron, to form a three part electron only if the plus tronnie finds partners to form a three part positron at the same time. Each of the two tronnies of the high energy photon becomes one of the tronnies orbiting the path of the central circling tronnie (302 in FIG. 6). I am not certain of the dimensions of the electrons. The dimensions must be non-zero since tronnies 304 and 306 must pass through the center of the path of tronnie 302. (The electron is definitely not a point particle.) The size of the electron may depend on the energy of the gamma ray that caused its formation. Once formed the electron might collapse into a very tight small and stable dynamic structure. The Coulomb forces holding the electron together are tremendous, the tronnie speeds are in excess of the speed of light and, as far as I know, the electron once formed may be indestructible by any known means other than by annihilation with its anti-particle.

Electron with Captured Tronnie Pairs

An electron (negatron) may capture one or more tronnie pairs and thereby increase its energy (mass). Thus, the speed of the electron, its energy, its mass is determined at least in part by the tronnie pair or pairs it captures. As the two negative tronnies orbit the path of the circling positive tronnie the three tronnies create fluctuating force fields which are rotating and are attractive for tronnies paired up in photons provided the wavelengths and frequencies match. Thus, one or more tronnie pairs (or photons) can be captured if the frequency of the tronnie pair or photon is resonant with the orbits of the tronnies in the electron. Once captured a tronnie pair will exert forces on the electron, propelling the electron. I have not figured out the precise configuration of the captured tronnie pairs. The net of all of the forces exerted will be a repelling force tending to drive the electron forward with the tronnie pair following behind. The plus tronnie of the tronnie pair might be attracted to the inside of the negatron to orbit in the path of the plus tronnie 302A shown in FIG. 6 leaving the minus tronnie of the photon to follow along behind the electron attracted to its trapped mate but applying a repulsive Coulomb force on minus tronnies 304A and 306A to give the negatron its speed. However, my belief is that both plus and minus tronnies circle electron 301 with the minus tronnie 305B on the same path as the plus tronnie 305A but following it at about ⅛ of a cycle behind the plus tronnie as shown in FIG. 6A. The electron attracts the plus tronnie and repells the minus tronnie. The plus tron circles the electron and attracts the minus tronnie following closely behind it. The minus tronnie is attracted to the plus tronnie only as long as it remains positioned at the proper location behind the plus tronnie. Repulsive forces from the two minus tronnies in the electron will not let the minus tronnie get any closer to the plus tronnie. The minus tronnie repells the electron radially as it circles the electron but this force is cancelled out to zero each cycle. However, if the electron is moving forward as shown in FIG. 6B, the minus tronnie also provides a forward force component on the electron. I believe this is the source of momentum and kinetic energy. If the electron (in a given reference frame) is accelerated from a velocity of zero to a velocity v, its trapped tronnie pairs will fall behind the electron as shown in FIG. 6B. The faster the electron is moving the farther behind the tronnies fall. This increases the forward force component applied by the trapped tronnies on the electron. If the electron is viewed from a reference frame moving with the electron the trapped tronnies will not be displaced to the rear of the electron and will not produce any forward force.

Electric Current

FIG. 7 shows a very simple electric circuit with 24-volt battery 142 and 24-volt lamp 146 separated by a one-mile copper pair with switch 156 near the battery. When the switch 156 is closed the light begins to glow almost instantly long before electrons could possibly travel the one-mile length of the copper pair. The popular explanation is that electrons near the battery push on other electrons so that an electron-domino effect pushes electrons that had been near the lamp through the lamp filament with the result that the effective speed of the electrons is a large fraction of the speed of light. The Ross Model explanation is that when the switch is closed minus tronnie pairs circling as a part of tronnie pairs in the copper wire near the switch are repelled by excess electrons just upstream of the switch that are now moving (relatively slowly) through the switch. These tronnies, circling at the speed of light cramped in the thin wire, jump at the opportunity to travel longitudinally down the wire to the lamp. When the tronnies reach the lamp region electrons in the region are repelled and bunch up at the end of the copper wire forcing the negative tronniess to circle in tight orbits. Plus tronnies join the orbits of the minus tronnies and the pairs orbit the electrons giving them increased energy allowing the electrons to pass through the high resistance tungsten filament. Tronnie pairs are released in the filament heating it to a very high temperature. The filament then cools itself by radiating high-energy photons (i.e., plus and minus tronnies) in the visible light spectral range.

FIG. 8 shows a light emitting diode. Here plus tronnies flow clockwise and minus trons flow counter-clockwise in the circuit as shown at 164 to the p-leg and the n-legs of the diode. Photons (each with one plus and one minus tronnie) are formed and emitted when the tronnies meet at the junction.

Proton and Neutron

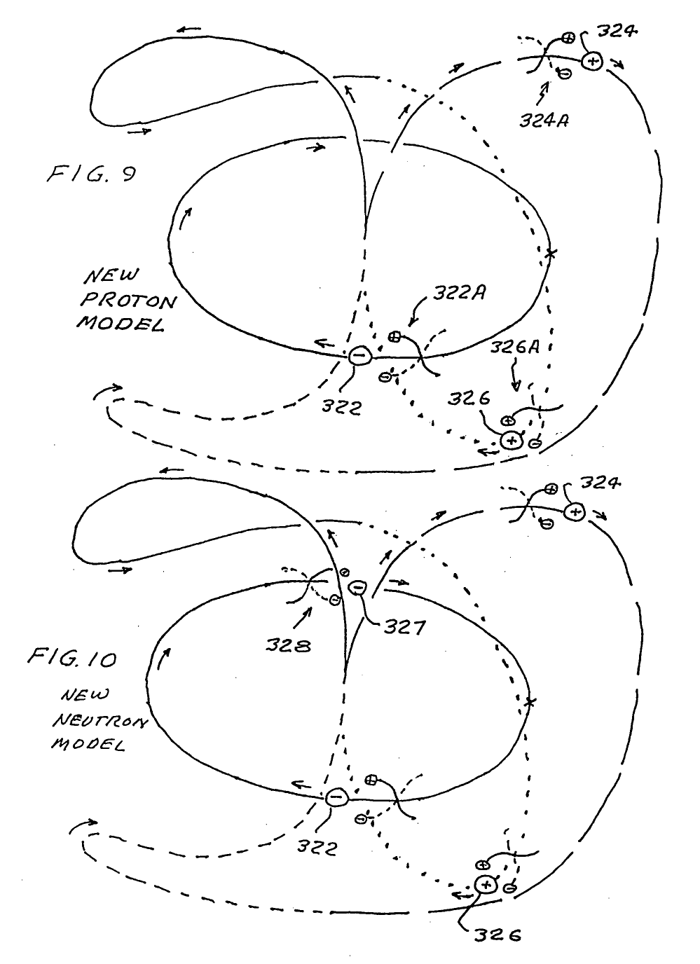

My preferred proton model 320 is shown in FIG. 9. This proton model is very similar to the positron version of my electron model shown in FIG. 6 except in the place of the minus and the two plus tronnies we have a negatron 322 in the circular loop and the two positrons 324 and 326 orbiting the circular loop. These electrons are being pushed in their paths by trapped high-energy photons (i.e., neutrinos) 322A, 324A and 326A. The frequency of the high-energy photons is high enough so that the energy/mass of the proton is increased by a factor of about 1800 compared to the energy/mass of an electron. For example, a photon having a wavelength roughly equal to the diameter of a proton would have a mass/energy equal to 900 times the electron mass. The reader should note therefore that the neutrinos 322A, 324A and 326A shown in FIG. 9 may be larger relative to the paths of the electrons than is indicated in the FIG. 9 drawing. I recognize that this model of the proton seems somewhat complicated, with one negatron, two positrons and three neutrinos pushing the negatron and the two positrons in their orbits. However, my understanding is that the ultimate products of a proton—anti-proton annihilation are positrons, negatrons and neutrinos. So maybe this model is correct. Each of the three electrons and their associated neutrino have features similar to what some people are calling quarks. Also, if the helical diameters of the neutrinos 322A, 324A and 326A are about the size of the proton, then they are going to feel the force of each other and each of the electrons in the proton. I suspect that the movements of all of these tronnies (in this model there are 15 of them: 7 minus and 8 plus) are precisely synchronized with each other with enormous Coulomb forces holding them dynamically in place. I am looking forward to some smart computer person creating a 3-D computer model corresponding to this model so we can watch all the little tronnies loop around each other in very, very, very slow motion.

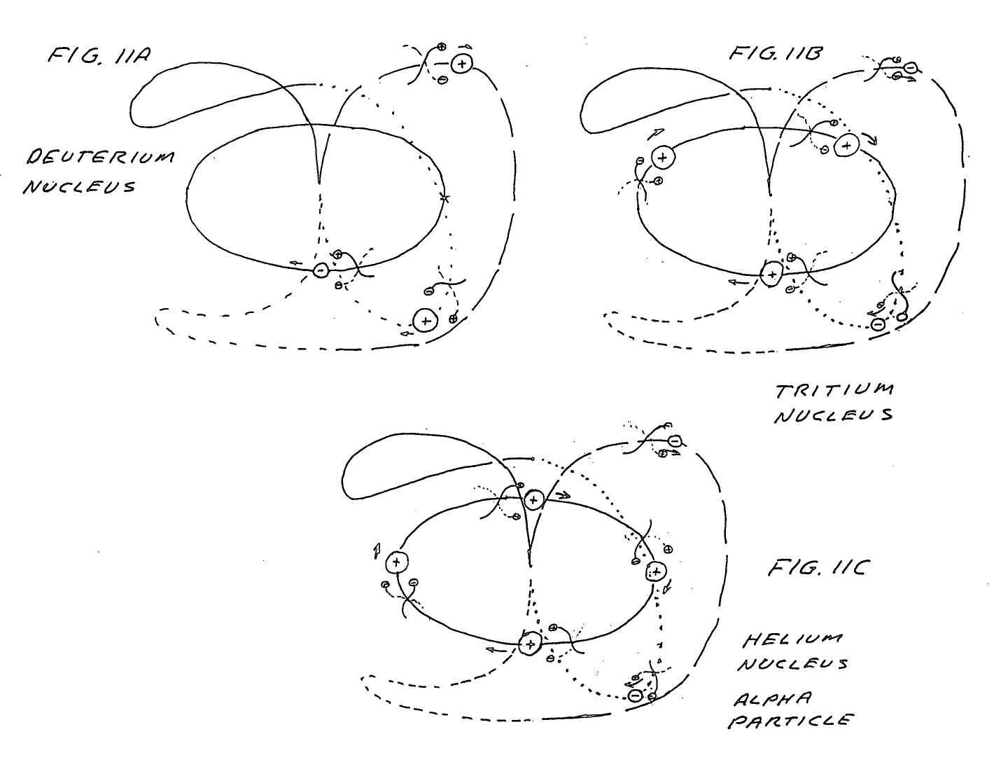

The anti-proton is just the opposite of the proton and comprises a positron in the place of negatron 322 in FIG. 10 and two negatrons in the place of positrons 324 and 326. Like the electrons, the proton and the anti-proton are held together by enormous Coulomb forces and are extremely stable except through the process of annihilation with each other.

The neutron would have an additional negatron (along with a corresponding neutrino [or high mass/energy photon] to drive it) added to the proton shown in FIG. 9. It may locate itself on the path of negatron 322 at the minus T/2 position (see FIG. 10); however, in my preferred model it orbits farther out near the outside of the paths of the positrons. The reader should keep in mind that the neutron is currently thought to be extremely stable inside a nucleus but very unstable (with a half-life of only a few minutes) outside the nucleus. I suspect as explained below that the neutron loses its identity and its electron once it gets inside the nucleus and the neutron then functions as a proton. Its electron is then shared by two or more protons, with the electrons of the nucleus functioning as the primary attractive forces holding the nucleus together.

Atomic Nuclei

I do not have a precise model of atomic nuclei. For each stable nucleus there may be several possible equilibrium configurations where the constituents of the nucleus are held together in Coulomb force wells. In FIG. 11A, I show a possible configuration for the deuterium nucleus. The deuterium nucleus according to the prior art is comprised of a single proton and a single neutron. My preferred model of a neutron, as explained above, is a proton orbited by a close in high-energy electron and the neutron becomes a proton inside the nucleus with the electron acting as glue holding the protons of the nucleus together. In the FIG. 11A drawing the electron follows a circular path driven forward by one or more captured high-energy photons (probably including a neutrino) and the two protons are orbiting the electrons path. I suspect high-energy photons are captured by each of the protons and contribute Coulomb forces to drive the protons in their orbits around the electron. I understand that the current scientific thinking is that the electron cannot exist inside the nucleus because to do so would violate Heisenberg's Uncertainty Principal. The Ross Model is surely at odds with this thinking. We have electrons and positrons inside protons! I suspect that for years we have been lead astray by Professor Heisenberg. According to the Ross Model the nucleus of atoms includes protons (each one comprising one electron and two positrons each of the three having at least one neutrino giving it extra mass and speed) and electrons.

FIG. 11B is a suggested model of a tritium nucleus. The prior art thinking is that this nucleus is comprised of a proton and two neutrons. In the suggested FIG. 11B model, three protons follow a circular path that is orbited by two electrons, all of the protons and electrons being driven on their paths by high energy photons.

FIG. 11C is a suggested model of an alpha particle (a helium nucleus). This is an extremely stable thing. Often, when large nuclei brake apart, out comes an alpha particle. Its preferred configuration in the Ross Model is very similar to the configuration of the electron, the positron, the proton and the anti-proton. Four protons circle equally spaced in a ring as shown in FIG. 11C. Two electrons orbit the ring in synchronization with the orbit of the four protons. The helium nucleus needs fewer neutrinos and gamma rays to drive the protons and electrons than are required in both the tritium nucleus and the deuterium nucleus, so when the nuclei of deuterium and tritium fuse the unneeded neutrinos and gamma rays are released (as heat energy) along with the extra neutron (i.e., a proton plus an electron). The reader should take notice that the proposed model of the helium nucleus suggests a good logical reason why orbiting atomic electrons in the helium atom do not spiral into the helium nucleus. The two electrons in the nucleus orbiting the path of the four protons shield the protons from two atomic electrons that orbit the helium nucleus.

I do not know that the neutron changes to an electron and a proton inside the nucleus. And I have developed descriptions of nuclei held together with Coulomb forces with the assumption that the neutron remains a neutron inside the nucleus. However, it just seems more logical that the neutron would split into the proton and the electron. First, it is easier to describe stable nuclei if there is a split. Second, I see no reason why the neutron should be more stable inside the nucleus than it is outside the nucleus. Outside its half-life is only a few minutes at which time it decays to a proton and an electron plus a neutrino.

Nuclei larger than the helium nucleus are built up with a the same building blocks of the three nuclei shown in FIGS. 11A-C; i.e., protons, electrons, and neutrino and gamma ray photons. The reader should keep in mind, however, that according the Ross Model, the basic building blocks are the plus and minus tronnies from which these building blocks and in fact everything in the universe is made.

I like this model of the alpha particle for several reasons. Note that the paths of the two electrons are for the most part outside the circle of the four protons. This may result in several alpha particles being attractive to each other at specific separations. At distances of a few nuclear dimensions, alpha particles are certainly repulsive to each other. However, there may be a net attractive force between alpha particles when they are close together. Thus it should be easy to make nuclei of many atoms merely by combining alpha particles. Most of the smaller chemicals in the periodic table are believed to have about the same number of neutrons as protons. According to preferred embodiments of the Ross Model, this means that in the nucleus there are about two protons for each electron or the same proportion as in the alpha particle. My guess is that in larger atoms many alpha particles exist in the nucleus as alpha particles and they are attractive to each other at nuclear dimensions. As the atoms become bigger a few extra electrons are sprinkled in as extra glue. In addition to alpha particles and electrons, protons (and perhaps some positrons) can be fitted in to fill out the periodic table. The main point is here that we do not need any kind of strong force or weak force to hold nuclei together. All we need is the Coulomb force.

Uncertainty Principal

Heisenberg's Uncertainty Principal enjoys wide support by modern scientists. Therefore, I am naturally reluctant to say it is wrong. I do suggest that scientists may want to think about its application in light of the Ross Model of the Universe and the existence (if I am right) of tronnies that are the building blocks of everything in the universe. For example, if an electron is comprised of three tronnies held together in dynamic equilibrium in their triple tronnie twirl as shown in FIG. 6 and that its energy (above its rest mass) is provided by photons trapped in its Coulomb force fields, then we should think of the electron to include its trapped photons. These trapped photons provide the electron with its velocity and thus its momentum. They also help create uncertainty as to the location of the electron. Since higher energy photons correspond to smaller photons, there may be some relationship between momentum of the electron and the position of the electron. What I'm saying here is that I, like a great many other people, do not fully understand the uncertainty principal, but it may be that it is not basically inconsistent with the Ross Model. If it turns out to be inconsistent with the Ross Model, we will have to see what that means. I, like Albert Einstein, would like to prove that the uncertainty principal is incorrect.

Heat and Temperature

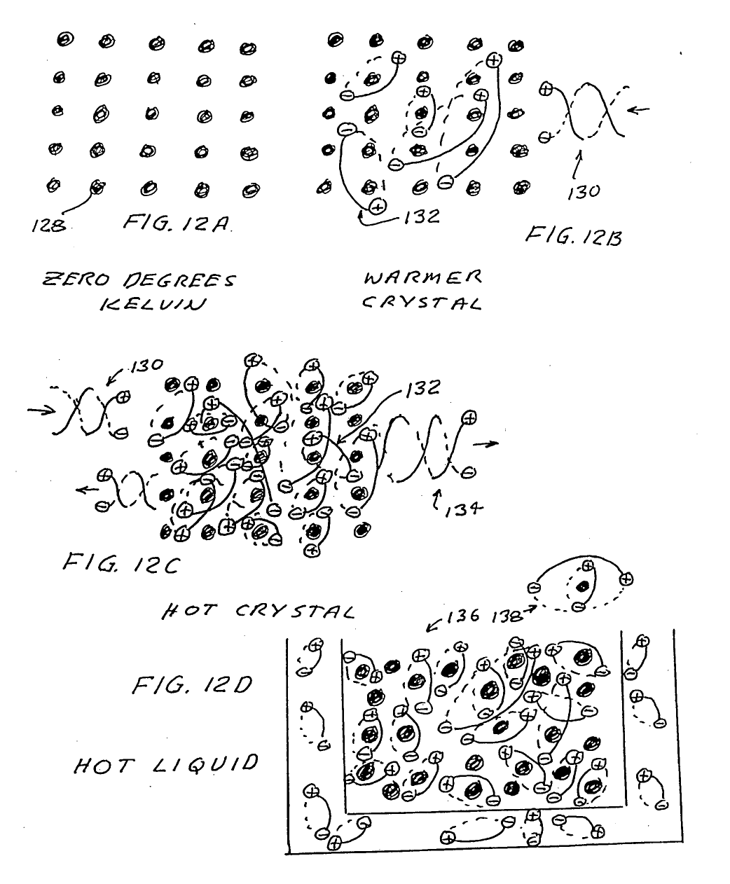

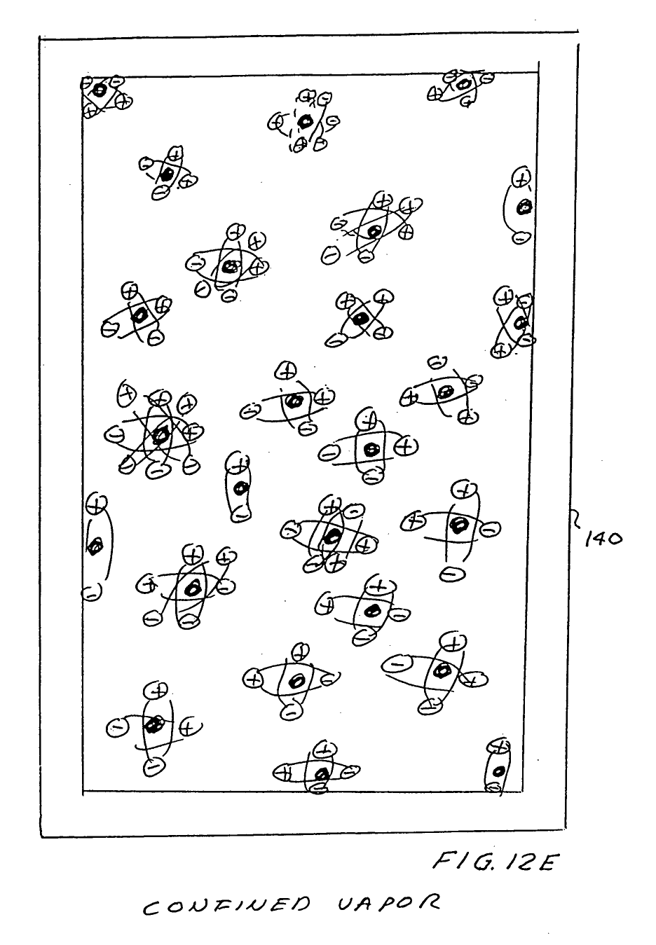

In this embodiment heat and temperature, of a solid, liquid or gas, are expressions of photons (or tron pairs) which have been captured and are temporarily located in the solid liquid or gas. According to this model, all atoms and molecules naturally include a number of tron pairs (neutrinos, gamma rays and other photons) that help define the basic atom or molecule in its natural unheated state (i.e., its absolute zero temperature state). FIG. 12A depicts the atoms 128 of a solid crystal at zero degrees Kelvin. The atoms of this crystal comprise tronnie pairs, but these tron pairs are part of the make-up of the crystal and there is no force within the crystal structure encouraging them to leave, even at a temperature of absolute zero. However, the crystal can accommodate a great many additional tronnie pairs, and if it is placed in an environment warmer than absolute zero, tronnie pairs will enter the crystal as indicated at 130 in FIG. 12B and may remain as shown at 132. The more tronnie pairs that enter through radiation or conduction, the warmer the crystal becomes. Some tronnie pairs may also leave, but there will be a net inflow until the crystal becomes in equilibrium with its environment. FIG. 12C depicts a hot crystal with tronnie pairs entering 130 and tronnie pairs leaving 134 and many remaining temporally trapped 132. Tronnie pairs may retain their entering frequencies inside the crystal or as the result of interactions inside the crystals with other tronnies that are part of the atoms or part of other tronnie pairs they may have their frequencies increased or decreased. If tronnie pairs are continuously added to the solid crystal faster than they are released the number of tronnie pairs in the crystal will grow and the tronnie pairs will become more and more crowded. This will cause the crystal structure to expand and eventually disruptive forces of all of these tronnie pairs will overcome the forces holding the atoms together in their crystal structure. The crystal may melt as depicted in FIG. 12D. The atoms of the crystal move about more or less randomly as indicated at 136 but Coulomb forces continue to provide a net attraction between the atoms. However, occasionally tronnie pairs circling an atom will produce net repulsive forces to cause atoms to evaporate and leave the melted crystal as shown at 138 taking tronnie pairs along. Continued heating of the melted crystal will put more and more tronnie pairs into the liquid. This has the effect of forcing the pairs into smaller and smaller circles (i.e., higher and higher frequency tronnie pairs) and as a result the tronnie pairs leaving as thermal radiation have on the average shorter wavelengths. Also, the shorter circles tend to cause the tronnie pairs to circle individual atoms. (In a molecular fluid such as water the tronnie pairs will tend to circle molecules or small groups of molecules.) This reduces the attraction between the atoms in the fluid and more and more of them will become disassociated from the liquid, i.e., they evaporate. FIG. 12E shows all of the atoms of the original crystal evaporated and completely filling the container as vapor. Each atom is encircled by a number of tronnie pairs producing a vapor of atoms and captured tronnie pairs and the atoms (with their associated tronnie pairs) repel each other and the container creating a pressure in the container. Adding more tronnie pairs to the vapor in the form of radiation or convection through the container will increase the number of tronnie pairs encircling each atom. Tronnie pairs travel from one atom to another and to and from the walls of the container producing a substantial equilibrium among the atoms in the vapor. The temperature is a measure of the number of tronnie pairs per atom throughout the process of the heating of the crystal from its absolute zero state to its hot vapor state.

Magnetism

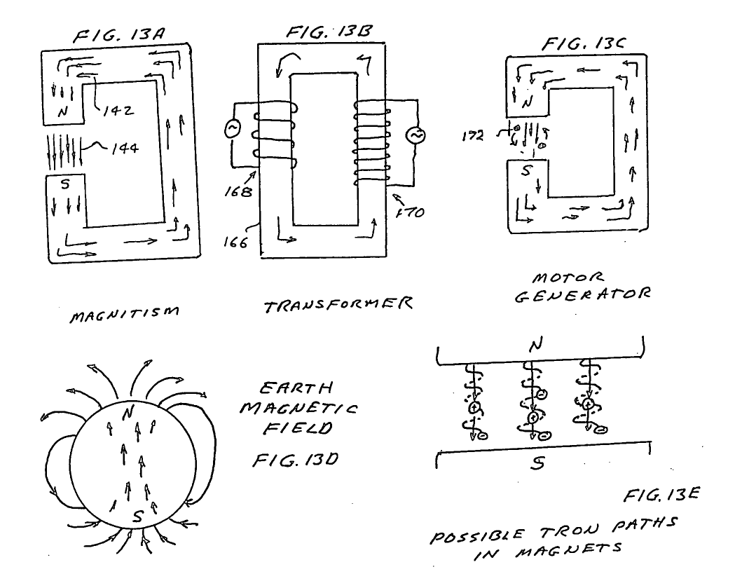

As indicated in the previous section, all solids above absolute temperature have a lot of captured tronnies. These tronnies normally come in as tronnie pair through conduction or radiation and tend to remain as tronnie pairs within the solid. However, a tronnie does not have to be paired up. What is important is that it be free to travel at the speed of light or greater. If a tronnie slows down it faces an infinite Coulomb force from immediately behind itself. The tronnie typically likes to be paired up because that allows the to go at a speed greater than the speed of light in a circle with its partner pulling him through his own force field at points half-way around the circle as shown at 86A in FIG. 2. However, if conditions are right the tronnie is just as happy making longer loops so long as the tronnie can do it at the speed of light or greater. This is what I believe happens in a permanent magnetic as shown in FIG. 13A. Here tronnies 142 loop around the magnet moving at the speed of light. They can continue across gaps as shown at 144 in this horse shoe magnetic. If this were a bar magnetic the tronnies would exit the bar at one pole, loop around on the outside and enter at the other pole. Magnets can be created with materials such as iron and a current carrying coil as is well known.

I have not figured out which tronnie takes the route shown by arrows 142 and 144 in FIG. 13A. I think it is the positive tronnies in most magnets and the negative trons orbit around the positrons in a helical pattern as shown in FIG. 13E. FIG. 13B shows a transformer. Here electrons flow in four loops 168 around iron core 166. The fields set up by the orbiting electrons and minus tronnies pushed along by the electrons allow plus tronnies to flow freely around iron core 166 at speeds equal to or greater than the speed of light. If the current in primary winding 168 is alternating then the direction of the tronnie flow will alternate accordingly. This will produce a circulating flow of negative tronnies around core 166 that will create a current in loop 170.

FIG. 13D depicts the earth's magnetic field. I believe that circulating metals in the earth's interior create conditions under which tronnies are able to travel through and around the earth as shown in the figure. Since their speeds are in the range of the speed of light or greater, the round trip is probably less than a second. FIG. 13C represents motors and generators, which involves conductors rotating in magnetic fields. I have not figured out exactly how electricity is generated and exactly how the flowing tronnies and electrons turn the motor shaft. I think it works like this: As a conductor 172 passes through the magnetic field (i.e., the streaming tronnies) shown at 172 in FIG. 13C plus tronnies in the conductor are forced in one direction and minus tronnies are forced in the opposite direction. When the conductor loops around and passes back through the streaming tronnies in the opposite direction then the tronnies in the conductor are forced in directions opposite those of the first pass. Another possibility is that the tronnies shown in FIG. 13E are captured into the conductor as it makes one pass through the streaming tronnies and exits the conductor into the stream when the conductor passes back through the stream in the opposite direction.

Chemical Energy

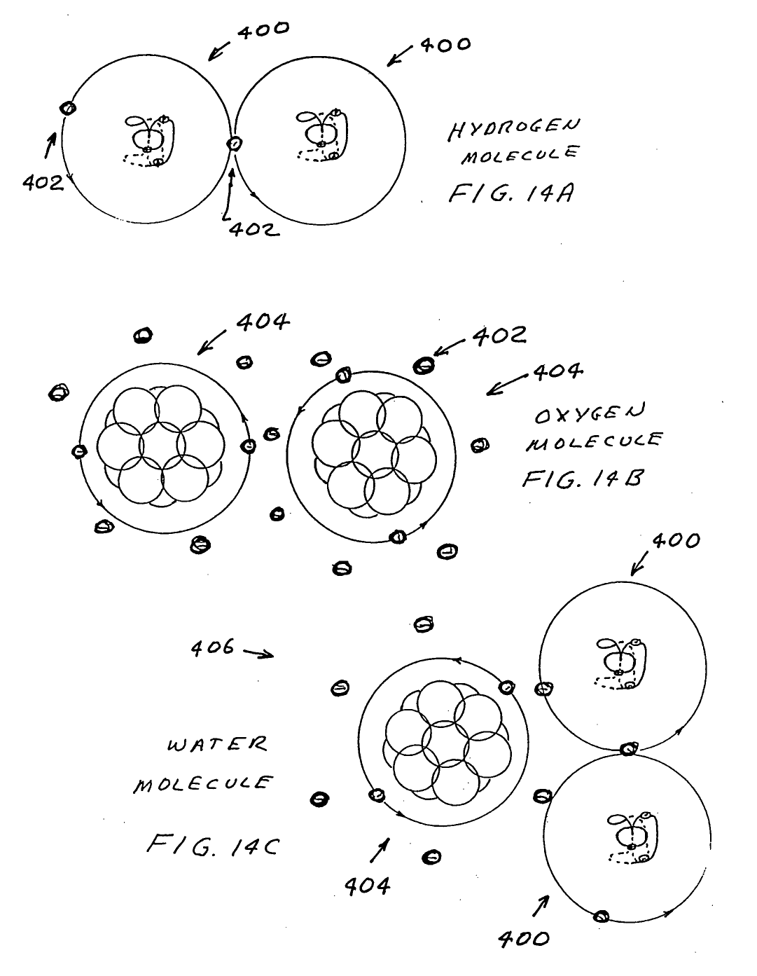

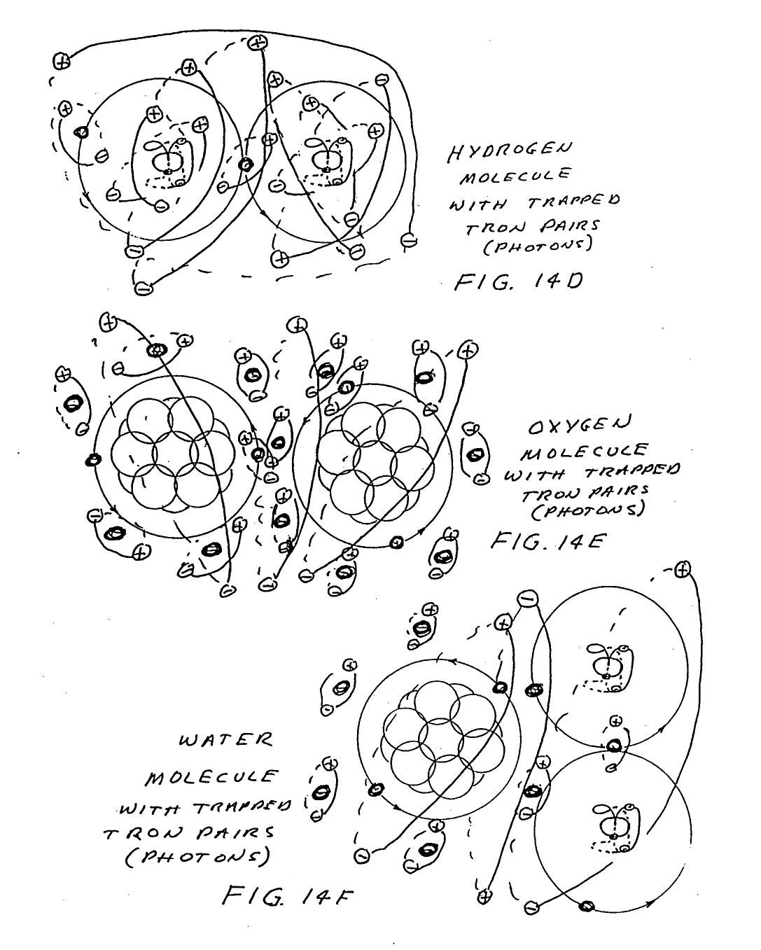

FIG. 14A depicts a hydrogen molecule which is two hydrogen atoms 400 sharing electrons 402. FIG. 14B shows an oxygen molecule, which are two oxygen atoms each with six electrons in their outer shells and sharing two electrons to complete the eight electrons desired shell. FIG. 14C depicts a water molecule H₂O 406. FIG. 14D depicts a hydrogen molecule like that shown in FIG. 14A but with a large number of trapped tronnie pairs. FIG. 14E shows an oxygen molecule also with a large number of trapped tronnie pairs. These numbers of tronnie pairs in the hydrogen and the oxygen is assumed to represent equilibrium states at a particular temperature. FIG. 14F depicts a water molecule at the same temperature as the hydrogen and oxygen temperatures, but according to the drawings the water molecule has around it many fewer tronnie pairs than the pairs in the hydrogen molecule plus one half of the tronnie pairs in the oxygen molecule. This example is suppose to show that when hydrogen burns in oxygen to form water the energy produced is excess tronnie pairs which are released in the process in the form of photons. The point here is that in all exothermic reaction the heat released is excess tronnie pairs. In many reactions heat must be added to make them go. In these cases the natural state of the product needs more tronnie pairs than the constituents at the same temperature.

Fusion and Fission

FIGS. 11A through 11C are representations of the nuclei of deuterium, tritium and helium 4. According to the Ross Model a helium nucleus is comprises of fewer neutrino and gamma ray photons than are comprised in the nuclei of tritium and deuterium combined. Therefore, when tritium and deuterium fuse these extra photons are released as heat energy along with a neutron. Thus, the excess tronnie pairs are released as photons, in this case very high-energy gamma photons plus some neutrinos. In fission I believe uranium 236 (U-235 plus a neutron) has more tronnie pairs (very high energy trapped photons) associated with it than the fission products resulting from the fission so that, again, heat energy is released in the form of high energy photons along with two or three excess neutrons.

Thermoelectric Effects

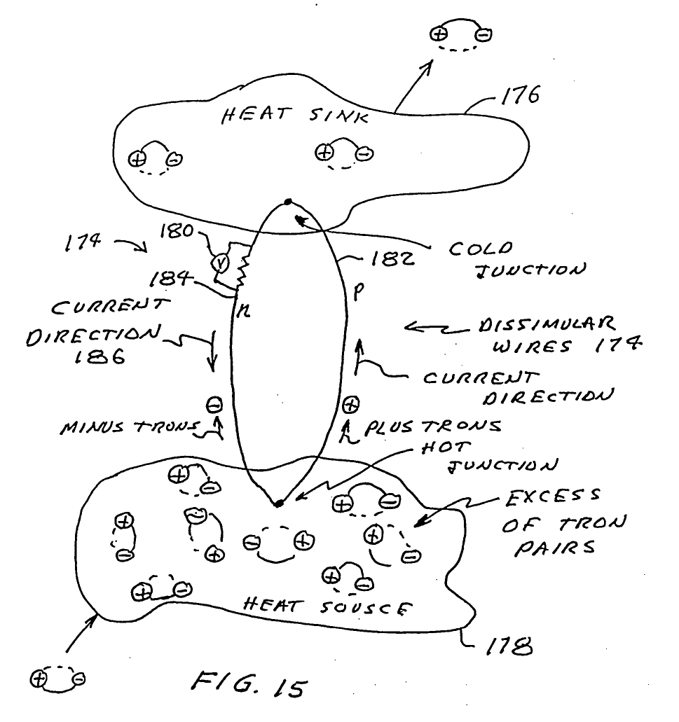

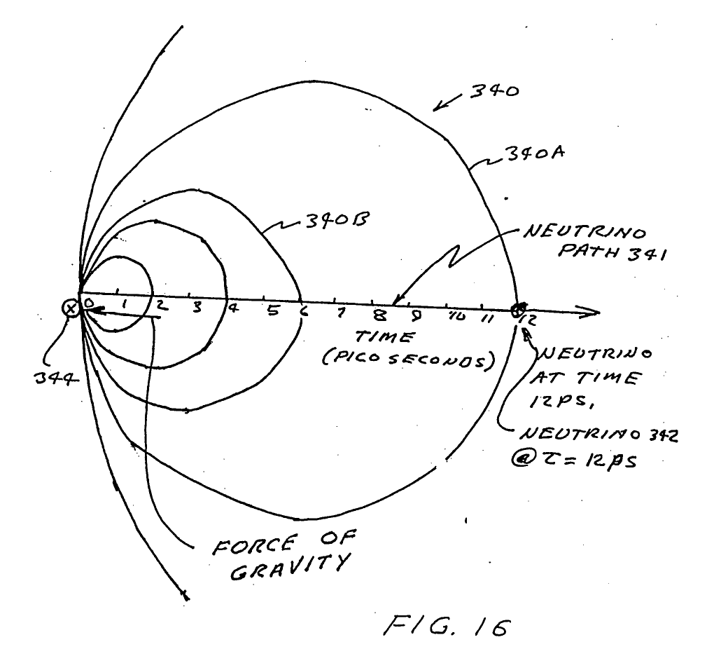

Electric energy can be generated directly from a temperature difference by reason of the thermoelectric effects. FIG. 15 depicts a thermocouple made from dissimilar wires 174 with one junction at cold heat sink 176 and the other junction in hot heat source 178. Voltmeter 180 measures the potential difference generated. As indicated the heat source contains many more tronnie pairs than the heat sink. Plus tronnies travel along p-leg 182 from heat source 178 to heat sink 176 and minus tronnies travel along n leg 184 from heat source 178 to heat sink 176. This results in a current as shown at 186 and a potential difference as measured at 180. The plus and minus tronnies combine at the heat sink as tronnie pairs that are identified as heat added to the heat sink.

Gravity

In prior art models of the universe, there is speculation that a particle called the “graviton” is the carrier of gravity although no one has ever seen a graviton despite extensive searches for them. The existence of neutrinos is well accepted in prior art theories with more than 150 million of them passing through every square centimeter of earth each second. In all references to them that I have seen there is no indication that neutrinos carry any charge or charges or has any relationship to gravity. There is some question in the prior art as to whether neutrinos have mass. According to the Ross Model, the neutrino is nothing more than a high frequency, short wave length photon (probably about a million times shorter than the dimensions of an atom and maybe even shorter than that). It like all photons has no net charge but carries two equal and opposite charges. Like all photons the neutrino is comprised of a plus tronnie and a minus tronnie that travel through space in an oscillating pattern. The width of the neutrino (i.e., the maximum separation of the two tronnies is much smaller than atomic dimensions so it passes right through almost all atoms in its path and is only very rarely stopped even when passing through bodies as large as the earth. FIG. 16 shows Coulomb fields 340 produced by a neutrino 342 from the sun passing through the earth. It is traveling through the earth at the speed of light or a substantial fraction of the speed of light so that in 12 pico-seconds it would travel:

D=(12×10⁻¹² s)(3×10⁸ m/s)=3.6 mm,

or somewhat less than 3.6 mm.

It like all photons is pushed by its own Coulomb forces as indicated at 342 in FIG. 16. Circle 340A represents a cross section of the field at t=12 ps that emanated from neutrino 342 at t=6 ps. Circle 340B is the field at t=6 ps that emanated from neutrino at t=3 ps. The reader should understand that the fields from all points along the path of neutrino 342 define spheres that intersect the path 341 just behind neutrino 342. Of these only field 340A is shown.

The new idea here is the effect of these fields on a charged element (such as an electron or the constituent parts of an electron [i.e., tronnies]) that is substantially stationary in the matter through which the neutrino is passing. The first thing to realize is that trons (such as a plus tron 344) near the path of a neutrino (as shown in FIG. 16) never feel effects of the neutrino until after the neutrino passes it. This is obvious from our earlier discussions of photons and from FIG. 16. However, after the neutrino 342 passes plus tronnie 344 plus tronnie 344 does feel the repulsive Coulomb forces emanating from the plus tronnie part of neutrino 342 and is repelled by it. In fact at every instant along the path 341 of neutrino 342 a Coulomb wave is emitted that repels tronnie 344 according to the physics of the Coulomb inverse square law. Thus, the matter in which tronnie 344 is trapped feels a force pushing it toward the sun (i.e., the origin of the neutrino). This is the source of the sun's gravity carried by the neutrino from the sun to the earth. Thus, neutrinos and other mass penetrating photons (if there are any) not gravitons are the carriers of gravity. “OK”, a reader might ask, “Where does the earth get its gravity attracting me to its surface?” I suspect that a significant portion of neutrinos from the sun are scattered from protons and maybe electrons in the earth and some are absorbed then later released in all directions. So (except for the neutrinos passing through the earth from the sun and other things) the total of the matter penetrating photons coming out from the earth is relatively uniform in all directions. These matter-penetrating photons apply a reverse force to the charged elements inside our bodies thus pushing us toward the center of the earth. I believe neutrinos are emitted from protons and possibly electrons inside nuclei and are absorbed by these protons and possibly electrons. They may also be captured and released from electrons outside nuclei and maybe electrons outside atoms. Thus, in a mass like the earth an equilibrium will be reached in which the number of neutrinos absorbed in all of the protons and electrons (and also neutrons if you want think of them as different from a proton plus an electron) in the earth reaches a constant level which means that the earth is also a major source of neutrinos that are emitted in all directions. This source is (according to this feature of the Ross Model) the carrier of the earth's gravity.

Black Holes

If neutrinos are the carriers of gravity, then black holes must emit an awful lot of them. My suspicion is that much of the matter sucked into black holes is destroyed by nuclear processes inside the black holes, releasing their neutrinos to provide the black hole's gravity to suck in more matter. Thus, the only thing getting out of the black hole is neutrinos that are then the agent for pulling more matter into the hole. The black holes are also sucking in the hydrogen dispersed in interstellar space and releasing its neutrinos to go out and get more matter.

Receding Galaxies

So, a reader might ask. Why are galaxies moving apart from each other. An answer may be that a tremendous number of hydrogen atoms and molecules are distributed sparsely in the inter-galactic space. These hydrogen atoms and molecules may absorb a percentage of neutrinos emitted from the galaxies including the black holes in the galaxies and then re-emit the neutrinos in random directions. Thus, reducing the effectiveness of these neutrinos as gravity carriers. However, longer wavelength photons do penetrate the intergalactic space (obviously because we can see them), but these are absorbed near the surfaces of the galaxies applying a repulsive force.

The End of the Universe

It may be that when a sufficient portion of the free hydrogen in the space between galaxies has been sucked into the black holes that apparently exists in the center of large galaxies, the neutrinos from the black holes of the separate galaxies will begin to pull all galaxies together into one gigantic black hole marking the end of our universe.

The Beginning of the Next Universe

When all or substantially all of the matter of our present universe has been sucked into this gigantic black hole, the universe will be left with only the black hole made up of very hot neutrons (actually protons [each of which is an electron and two positrons], an equal number of electrons and a tremendous number of trapped photons that makes the black hole the hottest hell imaginable) and neutrinos which have traveled out radially from the black hole. As long as matter is being sucked into the black hole, photons other than neutrinos trying to escape will be absorbed or scattered by the incoming matter. Any photons that in not going out radially will be overtaken by neutrinos and sucked back into the black hole keeping it as hot as hell. When there is no more matter coming into the black hole, then longer wavelength light can get out as long is it is heading in a radial direction. This escape of photons could produce a cooling of the black hole permitting neutrinos coming from the center of the black hole to pull the contents of the black hole into a softball size volume at which time the positrons and electrons making up the matter of the black hole are compressed together annihilating each other releasing the annihilation gamma rays and the neutrinos that had been the source of the velocity of the electrons and positrons in the neutrons. This will be the next big bang!

Multiple Universes

We could therefore speculate that several universes have preceded ours. And that other universes will follow ours after all the black holes in our universe have collapsed into our universe's deepest black hole. Maybe the grand plan is for each succeeding universe to be born in a big bang expand for about 50 billion years, contract for about 50 billion years and then provide in a new big bang the set of mass-less, volume-less charged particles for the next universe. So our universe may be the 17^{th} in the universe in this series of universees or maybe the 17 thousandth universe in the series. Whio knows. And where did the tronnies for the first universe come from.$ .

String Theory

I do not understand string theory; however, I do understand that many very smart people believe in it because it produces results that are consistent with experimental results. The problem is that the theory is too complicated. It requires several additional dimensions in addition to the three spatial and one time dimensions with which we are familiar. I cannot believe that God designing the universe would incorporate ten or more dimensions. I think He would do it as simply as possible. It may be that some of the features of the Ross Model are consistent with features of the string theory. Maybe the electron model shown in FIG. 6 is one of the extra dimension and the proton model shown in FIG. 9 is another and maybe the alpha particle shown in FIG. 11C is another.

Symmetry

This model of the universe provides perfect symmetry, an equal number of plus and minus tronnies, of which the entire universe is constructed. If a plus tronnie were to combine with a minus tronnie, both would vanish into nothingness with nothing left over, no mass, no energy, no nothing. Thus, we can imagine that since we have an equal number of minus tronnies and plus tronnies and since each combination of plus and minus trons equals nothing; the universe could someday return to nothing. Therefore, it seems logical that the first universe universe could have come from nothing. I do not have a suggestion as to how this could be done. That is something we need to work on.

Model is Evolving and Getting Better

The reader should understand that this theory is not fully developed. It has been evolving for about three years. It started with an attempt to show that protons could be made from positrons and electrons. A five electron model was proposed (three positrons and two electron with the electrons orbiting one of the positrons fast enough that their velocity very close to c would increase their mass by about 900 times. Later on I developed the idea that electrons must be made from photons. This seemed likely since that is how electrons are made in pair production. What was added was the notion that both photons and electrons are made from charged things, called tronnies. Since tronnies have no mass, they could go faster than the speed of light; therefore, they could be pushed by their own Coulomb force field. My first attempt at an electron model had one tronnie in the center with two opposite tronnies orbiting. Once I had an electron model made from the constituents of photons, I went to work trying to make everything out of tronnies. I developed models for heat, electricity, magnetism. I at this point convinced myself that everything in the universe was made from tronnies. My first electron model was not very satisfying because nothing seemed to keep it from collapsing on itself. Also, it was hard to see the central tronnie going as fast as the speed of light. Then I developed the tripple tronnie twirl and this model seemed perfect. It had spin. It had to have a non-zero volume since the outer tronnies had to pass through the circlular path of the central tronnie. Not only that, it seemed to provide a good model for the proton especially if I was correct that captured tronnie pairs provided electrons with their excess energy (and mass). Having gone this far, maybe I really could show the possibility of everything in the universe being made from tronnies and all forces in the universe being derived from tronnies. The most difficult was gravity. The breakthrough was my realization that neutrinos might be photons and (like photons) might be comprised of two opposite charges. This is almost too simple. I had tried for almost three years to describe gravity in terms of the Coulomb force. My calculations would not work out. I could never come up with an inverse square relationship. Now, however, could neutrinos carry the gravitational force? Neutrino flux is huge and it decreases from its source as the inverse square. I had earlier showed that a photon (or a tronnie for that matter) traveling at the speed of light exerts no force in front of itself pushing toward its source. However, I then realized that it exerts plenty of force behind itself. And almost all neutrinos form the sun pass completely through the earth, billions and billions and billions of them each second, all pushing the earth back from wince the neutrinos came. This must be gravity! I think I got it! I think I got it!

Correctness of Models

The models presented in this specification (including the proton and the model of atomic nuclei presented above) constitute a major departure from the most widely accepted theories explaining the makeup of nuclear particles. The reader should understand that the models presented herein are evolving. Some are going to be proven incorrect in all likelihood. I expect to develop better models. I am sure others will also if it turns out that I am generally on the right track with the concepts described in this specification. If all of my ideas are not correct, I will be in good company. Newton and Maxwell did not get it right in every situation. If these models are anywhere close to being correct all physics books written during the past 20 years will have to be substantially revised. I recognize that many of the smartest people in the world have devoted their lives to efforts directed at explaining the makeup of these nuclear particles. I have described models in the very long shot belief that they might be correct or that they are close to correct. I have presented these models as patent applications for three reasons: (1) I am a patent attorney (a long time ago I used to be a nuclear engineer) and I am familiar with patent applications as a technique for publishing discoveries, (2) a patent application is at least initially kept secret and can be abandoned, or corrected in continuations-in-part so if I learn soon that I has made foolish mistakes, I can perhaps minimize my embarrassment and (3) in the unlikely event I am right, I would like to have some control over the applications of my discoveries. However, all of my current and past clients will have a royalty-free right to practice (in their current business activities or in any current or past anticipated research and development) under any resulting patent.

### Testing the Models

Many processes are available for utilizing, testing and evaluating the models described herein. One process is for a person experienced in modern nuclear physics to evaluate the models as they have been presented in this specification. This can easily be accomplished with a hand calculator.

### Computer Models

A more sophisticated model would be to utilize a digital computer model incorporating one or more of the models. It should be fairly simple to model the trons, the positrons the negatrons the protons and neutrons in the electron and proton models and determine if they are stable. If I am right, these models will show that the electron and proton and their antiparticles should be enormously stable except when opposites meet. By making the computer model a little more complicated, it should be feasible to determine how hard it would be to make a proton using the technique described above for doing that. Perhaps then the computer model could be extended to predict the formation of protons in the models during the process that followed the big bang. Once the electron, proton and neutron have been modeled on a digital computer it would be relatively simple to create similar computer models to examine the Nuclear Models. After these models are created investigations could be preformed to determine if a technique can be developed to breakup the proton and release its energy. If this could be done economically, we would have what may be the most important invention since the beginning of civilization. The models of current flow described herein should be extremely important if they are correct in understanding current flow in everything from integrated circuits to electric power transmission circuits. The techniques herein should also be very valuable in the understanding and design of communication systems from radio, microwave to fiber optics. In each case a heretofore unknown thing, the tronnie, is the workhorse in making these systems work. Now we should really understand why these systems work and as a result maybe make them work better.

### Nuclear Tests and Experiments

If computer modeling shows that the models are correct or that modifications or derivations of the models are correct. A next step is to perform some experiments with particle accelerators to test the models or aspects of the models. It may be that current accelerators do not have the capabilities to properly investigate the models. If so and if the models are shown to be possibly correct then perhaps accelerators can be built to properly test the models. Actually, since the filing of the parent to this Application, Applicant has read that already experiments have been conducted in which positrons and negatrons were fired at each other each with high energy and the result was protons! Also, as referred to above, experiments have been reported in which the annihilation of protons and anti-protons produced electrons and positrons. We have known for many years that electrons and positrons can be produced form photons and that the annihilation of electrons and positrons produce photons. All of these experiments support the models described above.

### Trons Deserve Their Own Unit

Applicant believes that if his model is correct and the entire universe is made of these trons, each having a particular charge approximately equal to the values set forth above; the magnitude of that charge should be considered the most important thing in the world—important enough to rate its own value. And also the other forces at work in the universe all of which will be, one way or other, derived from these charges should be spoken of in terms of the quantity of these charges and not vice versa. Applicant has thus generated a new term that represents the exact magnitude of the charge of a tron. That term is the “Ross” the symbol for a Ross is “R”. Thus, the charge of a plus tron is +1 Ross or +1R. The charge of a minus tron is minus 1 Ross or −1R. The plural of Ross is Ross (like the plural of deer is deer). Therefore, one Coulomb is equal to about 6.25×10¹⁹ R. Since force between charges is the product of the two charges divided by the square of the distance between them, force is expressed as Ross per square meter (R²/m²). Thus, the attractive Coulomb force between a plus tron and a minus tron positioned 5.3×10⁻¹¹ meter apart is equal to 3.56×10²⁰ R²/m². That force in Newtons is 8.2×10⁻⁸ N; thus, one Newton equals 4.34×10²⁷ R²/m².

### No Quarks, No Special Weak Force and No Strong Force

This model shows how nuclei can be held together by Coulomb forces which unquestionably exist. Therefore, there is no need to invent nuclear forces for which there is no proof of existence such as the special weak nuclear force and the strong nuclear force. Also, since the above model shows how protons and neutrons can be held together in the nuclei of atoms there is no need to invent quarks for which there is no good experimental evidence.

While preferred embodiments of the present invention are described above, the reader should not construe the present invention as limited by the above description. In fact persons skilled in nuclear physics will envision many other possible variations within the scope of the present invention. The reader may note that the proton shown in FIG. 9 and the particles shown in FIGS. 11A, B and C all comprise negatrons and positrons zooming around in circles and loops. These circling and looping charges may encourage tronnies near the particles to loop through and around the looping electrons creating tiny electric magnets. These loops could extend out of one particle into and through another; thereby helping to hold nuclei together. This may also be happening on an atomic scale helping to hold groups of atoms together. These models therefore may be very useful in describing physics issues such as nuclear magnetic resonance and superconductivity. The reader should note that the proton model, unlike the alpha particle seems of have the two positrons on the outer regions of the dynamic structure. This would seem to invite the electron in the hydrogen atom to come crashing into the nucleus. However, this model can also be viewed as two positron orbiting in a common path on a rotating plane with the electron offset and extending out from the rotating plane and rotating with it. It may be that the atomic electron does not venture too close to the proton because to do so it would have to come too close to this nuclear electron as it swings around billions of times per second. Also, it is certainly likely that someone who knows a lot more than me about proton experimental data will propose the true model of it based on my basic concept of everything in the universe (including protons) being made from nothing but tronnies. I welcome the help. Accordingly, the reader is requested to determine the scope of the invention by the appended claims and their legal equivalents and not by the above examples.

I claim:

1) A process for modeling elements of the universe utilizing in models negatively charged tronnies, each having zero mass and a negative charge of about 1.9×10⁻¹⁹ Coulomb and positively charged tronnies, each having zero mass and a positive charge of about 1.9×10⁻¹⁹ Coulomb, said process comprising:
A) assigning an electric force field to each plus tronnie which expands out spherically from each of said plus tronnie with a velocity equal to the vacuum speed of light and produces an attractive Coulomb force on minus trons and a repulsive Coulomb force on plus tronnies,
B) assigning an electric force field to each minus tronnie which expands out spherically from each of said minus tronnie with a velocity equal to the vacuum speed of light and produces an attractive Coulomb force on plus trons and a repulsive Coulomb force on minus tronnies,
C) allowing some or all or said tronnies to be repulsed by their own force fields and to be repulsed and attracted by force fields from other tronnies so as to attain velocities equal to and greater than the vacuum speed of light, and
D) using said plus tronnies and said minus tronnies to model elements of the universe.

2) The process of claim 1 wherein everything in the universe is comprised of only said plus and minus tronnies.

3) The process of claim 1 wherein a photon is modeled as being comprised of one plus tronnie and one minus tronnie traveling together with each tronnie being pushed by its own force field and attracted by the force field of the other tron.

4) The process of claim 3 wherein said plus tronnie and said minus tronnie are modeled as traveling in a double helix pattern.

5) The process of claim 1 wherein a neutrino is modeled as being comprised of a plus tronnie and a minus tronnie.

6) The process of claim 1 wherein a negatron is modeled as being comprised of a plus tronnie and two minus tronnies.

7) The process of claim 1 wherein a positron is modeled as being comprised of a minus tronnie and two plus tronnies.

8) The process as in claim 6 wherein said plus tronnie is modeled as traveling in a circular path or an approximately circular path and said two minus tronnies are modeled as orbiting helically around said circular or approximately circular path resonantly with said plus tronnie.

9) The process of claim 1 wherein a nucleus of an atom is modeled as being comprised of protons and neutrons held together with Coulomb forces.

10) The process of claim 1 wherein a magnetic force is modeled as being produced by the flow of tronnies into and out of magnetic material.

11) The process of claim 18 wherein the magnetic material is the core of the earth and the tronnies are modeled as flowing into and out of the earth at locations near the north and south poles.

12) The process of claim 1 wherein the entire universe and its evolution before and after the big bang is model using only plus and minus trons as building blocks.

13) The process of claim 1 wherein neutrinos are modeled as high-energy photons.

14) The process of claim 21 wherein the neutrino is modeled as a carrier of gravitational force.

15) The process as in claim 1 wherein galaxies are modeled as being pushed apart from one another by photons.

16) The process of claim 1 heat and temperature of an object is modeled using tron pairs.

17) The process of claim 1 wherein tronnie pairs circling atoms or molecules are treated as causing phase changes from solid to liquid and from liquid to gas.

18) The process of claim 1 wherein tronnies are utilized to represent at least in part a flow of electric current in a conductor.

19) The process of claim 1 wherein tronnies are utilized to represent transfer of nerve signals through portions of a living animal.

20) The process of claim 6 wherein said negatron is modeled as a high energy negatron comprising a captured photon providing a force propelling said high energy negatron.
